(19) United States
(12) Patent Application Publication
(10) Pub. No.: US 2014/0024136 A1
(43) Pub. Date: Jan. 23, 2014

(54) MAGNETIC PARTICLE SEPARATOR

(71) Applicants: Derek L. Chappell, Princeton, NJ (US); Donald V. Conway, Scotch Plains, NJ (US); John Moriarity, Morrisville, NC (US)

(72) Inventors: Derek L. Chappell, Princeton, NJ (US); Donald V. Conway, Scotch Plains, NJ (US); John Moriarity, Morrisville, NC (US)

(21) Appl. No.: 13/837,571

(22) Filed: Mar. 15, 2013

Related U.S. Application Data
(60) Provisional application No. 61/708,827, filed on Oct. 2, 2012.
(60) Provisional application No. 61/673,312, filed on Jul. 19, 2012.

(51) Int. Cl. G01N 1/40

(52) U.S. Cl. CPC G01N 1/405
USPC 436/501; 422/527

(57) ABSTRACT

A magnetic particle separator (200) for use with a microplate (214) in methods employing magnetic particles, said magnetic particle separator (200)comprising a plurality of magnets (204) secured to a base plate (202) by a plurality of spacers (206), wherein the first ends of said plurality of spacers (206a) are secured to the base plate and the second ends of said plurality of spacers (206b) are secured to said plurality of magnets (204) and whereby said plurality of magnets (204) are separated from said base plate (202) by a distance of at least 15 mm. A magnetic particle separation system (900) comprising a magnetic particle separator (200) and a microplate (214) are also disclosed. Also disclosed are methods of using the magnetic particle separator (200) and magnetic particle separation system (900) to separate magnetic particles and bound antibodies.

### BACKGROUND OF THE INVENTION

Immunoprecipitation is a technique that is frequently used for precipitating a protein antigen out of a biological sample using an antibody that specifically binds to the particular protein to be analyzed. In a version of this technique, a biological sample containing a free antigen solution is deposited into the wells of a flat plate having a multiplicity of wells used as small test tubes. The flat plate with the wells is called a microtitre plate, a microwell plate, or a microplate. Antibody coated magnetic particles (e.g., superparamagnetic beads) are then added to the wells of the microplate and mixed with the free antigen solution. A reaction occurs between the antibody and the free antigen in the wells, whereby antibody-antigen complexes become bound to the magnetic particles. A pipette (which may be manually- or robotically-operated) is then inserted into each well of the microplate in an attempt to remove as much of the unbound free antigen solution from the wells as possible without removing the bound antibody-antigen complexes. However, because a significant portion of the bound antigen-antibody-magnetic particles have collected in or near the bottoms of the wells in the microplate, it is often difficult to remove the unbound solution from the wells without also removing antigen-antibody complexes bound to the magnetic particles.

To deal with this problem, devices and techniques have been introduced and used to try to provide better separation between the antibody-antigen complexes bound to the magnetic particles and the remaining unbound solution in the microplate wells. The conventional separators operate by positioning magnets next to the sides and bottoms of the wells in the microplate so that the magnetic particles or beads (and therefore, the antigen-antibody complexes bound thereto) are pulled to the sides and bottoms of the wells closest to the magnets. It has been found, however, that removing the desired volume of unbound solution (supernatant) from the wells without disturbing and possibly removing the bound magnetic particles can be still be a significant challenge because, based on the geometries of the microplates (especially “deep well” microplates) and the placement of the magnets relative to the wells in the microplates, far too many magnetic particle-bound antigen-antibody complexes still remain at, or very close to, the bottoms of the wells. Thus, a substantial quantity of magnetic particle bound antigen-antibody complexes are frequently removed from the wells inadvertently when a pipette or similar apparatus is inserted too far into and too close to the bottoms of the wells. Removing too many of the magnetic particle-bound antigen-antibody complexes from the wells can sometimes be avoided by inserting the pipette only a small distance into the wells, thereby attempting to keep the pipette away from the bottoms of the wells. But this technique typically leaves far too much unbound solution in the wells with the magnetic particle-bound antigen-antibody complexes. Accordingly, there is significant need for a more effective device and system for separating magnetic particles (and objects attached thereto, such as antigen-antibody complexes) and for moving these magnetic particles and bound antigen-antibody complexes away from the bottoms of microplate wells. The need is especially acute when the microplate is a high-volume “deep-well” microplate (i.e., microplates having wells capable of holding at least 1.0-2.0 mL of solution).

### SUMMARY OF THE INVENTION

Embodiments of the present invention address the above-described need by providing devices and methods that facilitate separation and removal of increased volumes of unbound sample solution from the wells of a microplate, especially deep-well microplates, with minimal disturbance to the bound magnetic particles in the solution. Embodiments of the present invention generate stronger and more effective magnetic fields for separating magnetic particles and analyte from the biological sample by utilizing a base plate, a plurality of magnets, and a plurality of spacers, each of the magnets being connected to and spaced apart from the base plate by a spacer. The spacers serve to position the magnets along the sides of the wells and further away from the bottoms of the wells so that the magnetic fields generated by the magnets pull the magnetic particles (and the analyte bound thereto) solely to the sides of the wells, thereby substantially clearing the bottoms of the wells of magnetic particles and bound analyte. The increased separation permits more efficient removal of unbound free antigen solution from the wells using pipettes because the pipettes can be inserted all the way to the bottoms of the wells without disturbing the magnetic particles and bound antigen-antibody complexes aggregated at the sides of the wells.

In general, embodiments of the present invention provide a magnetic particle separator for use with a microplate, comprising a base plate, a plurality of magnets and a plurality of spacers. The spacers serve as holders for the magnets and also provide separation between the base plate and the magnets. The separation between the base plate and the magnets is preferably at least 15 mm, more preferably at least 25 mm, more preferably at least 40 mm and most preferably at least 50 mm. Each spacer is secured at one end to a magnet, and, at its other end to the base plate. In some embodiments of the invention, each of the magnets is secured to a spacer such that the long axis of the spacer is perpendicular to the base plate. The spacers may be extended vertically or horizontally from the base plate, so long as the spacers and the magnets disposed at the ends of the spacers are configured so that, when the separator is joined with a suitable microplate, the spacers and the magnets disposed thereon are configured to pass easily into the recesses between the wells of the microplate to position the magnets adjacent to the sides of the wells of the microplate and away from the bottoms of the wells, as shown in the attached FIG. 2B. The spacers are typically cylindrical. However, spacers of other suitable shapes may also be used.

Embodiments of the magnetic particle separator of the present invention may be configured to be compatible with microplates having different numbers of wells, including but not limited to, 6, 12, 24, 48, 96, 384, 480 or 1536 wells. Typically the wells in these microplates are 30 mm deep, 50 mm deep, 80 mm deep, 100 mm deep, or some depth between 30 and 100 mm deep (although embodiments of the present invention may also be configured to work with microplates having wells outside of that range). To achieve a desired configuration, the base plate of the magnetic particle separator may be constructed such that it contains a plurality of openings arranged in a predetermined pattern according to the number of wells (or recesses between wells) in the particular microplate being used. If a 96-well microplate is used, for example, the base plate may be fabricated to include twenty-four openings, to which individual spacers for holding the magnets may be secured. The base plate may be fabricated from any non-magnetizable material, such as for example, polyethylene or another polymer. The base plate typically has a thickness of approximately ⅜ to ⅝ inches, although base plates with other dimensions may also be used.

The plurality of spacers may be secured to the openings in the base plate by appropriate techniques, including for example, press fitting. The spacers may be fabricated of any suitable non-magnetizable material, such as stainless steel, for example, that can support and hold the magnets in a fixed position to the base plate and facilitate insertion of the magnets and spacers into the recesses between the wells of the microplate. Although the spacers are generally 15-50 mm in length, the skilled artisan would recognize and appreciate that suitable spacers may be longer or shorter, depending on the dimensions of the recesses of the selected microplate.

In some embodiments of the invention, the magnets are magnetized or charged perpendicular to their length (i.e., diametrically magnetized), hence the poles are located on the sides of the magnets. The magnetic field vectors are thus directed to the sides of the magnets, with the vectors pointing away from the North Pole and towards the South Pole. Diametrically charged magnets are particularly advantageous in the present invention since the magnetic field vector pattern runs in the same direction to which the magnetic particles are targeted, i.e., towards the sides of the microplate wells positioned adjacent to the magnets. In addition, diametrically charged magnets provide greater surface area for attracting magnetic particles. In other embodiments of the invention, the magnets are charged parallel to this length (i.e., axially magnetized), with the poles thereby located on the ends of the magnets. The magnetic field vectors are directed to the ends of the magnets, with the vectors pointing away from the North Pole and towards the South Pole. In some embodiments of the present invention, the magnets may be oriented so that the magnetic field vectors of the magnets are approximately parallel to the long axes of the wells in the microplate, while in other embodiments, the magnets are oriented so that the magnetic fields are approximately perpendicular to the long axes of the wells in the microplate. Typically, though not necessarily, the respective magnetic fields of the plurality of magnets are all oriented in the same direction.

The present invention also encompasses a method of making a magnetic particle separator. In an embodiment of the method, a base plate having multiple openings arranged in a predetermined pattern or configuration is produced using appropriate machinery, such as a drill, to produce openings (holes) in the base plate. Each of the spacers is bored so as to produce a bore hole for receiving one end of a magnet. The spacers are then secured to the base plate by, for example, press fitting one end of each spacer into the openings in the base plate. One end of each of the magnets is then inserted into the bore hole of each one of the spacers by suitable methodology, such as press-fitting.

One embodiment of the present invention may be manufactured, for example, by boring out the centers of 24 stainless steel syringe tubing holders. Beginning with stainless steel syringe tubing holders that are 1 inch long and have an outside diameter of 0.125 inches and an inside diameter of 0.0625 inches, the tubing holders were modified by drilling bores into one end of each tube, the bores being approximately 0.200 inches deep. This drilling process includes successively drilling bores with diameters of 0.110 inches, 0.116 inches and 0.118 inches to obtain the proper inside diameter to install the magnets. The other (un-bored) ends of each one of the 24 syringe tubing holders are then press-fitted into 24 openings, respectively, in the base. Then, 24 diametrically-charged magnets are inserted into each one of the 0.118-inch bore holes in the free ends of the 24 syringe tubing holders, respectively.

Embodiments of the present invention also provide a magnetic particle separation system. The system comprises a microplate having wells for holding biological sample and recesses formed between the wells, and a magnetic particle separator comprising: a) a base plate, b) a plurality of magnets and c) a plurality of spacers. The spacers are interposed between the base plate and the magnets such that when the magnets and the spacers are inserted into the recesses of the microplate, the magnets are positioned adjacent to the sides of the wells. Notably, when the microplate and the magnetic separator are joined together by inserting the plurality of magnets into the recesses of the microplate, the plurality of spacers imposes a sufficient distance between the plurality of magnets and the bottoms of the wells so that the plurality of magnetic fields produced by the plurality of magnets cause the magnetic particles in the plurality of biological solutions to be attracted to the sides of the plurality of wells and away from the bottoms of the wells. Depending on the geometry of the wells and the strength of the magnets used, a sufficient distance between the bottoms of the wells and the magnets may be achieved by using spacers having lengths equal to not less than one third of the well depth, spacers having lengths equal to not less than half of the well depth, or spacers having lengths equal to not less than three quarters of the well depth.

Typically, but not necessarily, the separator is configured to position one magnet between every 4 wells so that the magnetic fields produced by the magnets cause the magnetic particles in the biological sample to aggregate along the sides of the wells closest to the charged magnets. In preferred embodiments of the invention, a substantial portion (e.g., a portion of at least 15 mm in length) of each one of the plurality of spacers passes into the recesses of the microplate so that the distance between the bottoms of the wells and the magnets adjacent to each well is 15 mm or greater. In some embodiments of the invention, the length of the spacers may be selected (or adjusted), depending on the well depths of microplates used, in order to cause the magnetic particles suspended in biological sample solutions to move away from both the tops and the bottoms of the wells.

In another aspect of the present invention, there is provided yet another method of separating magnetic particles that are suspended in a biological sample in the wells of a microplate. This method comprises using a magnetic particle separator or magnetic particle separator system of the present invention to apply a plurality of magnetic fields to the magnetic particles suspended in a plurality of wells of a microplate. The magnetic fields are applied by attaching the magnetic particle separator to the microplate such that a plurality of magnets attached to the spacers move into positions that are adjacent to the sides of said plurality of wells, and the magnetic fields produced by the magnets cause the magnetic particles suspended in the biological samples in the plurality of wells to aggregate against the sides of the plurality of wells, respectively, next to the magnets and away from the bottom of the wells.

In yet another aspect of the present invention, there is provided still another method for isolating an analyte from a biological sample. The method comprises: a) combining magnetic particles and the biological sample in the wells of the microplate, thereby producing a mixture; b) incubating the mixture under such conditions that the analyte binds to the magnetic particles; c) applying a magnetic field to the incubated mixture in the wells to cause the particles and bound analyte to move toward the sides and away from the bottoms of the wells; and d) recovering the magnetic particle bound analyte. The magnetic field is applied to the magnetic particles in the wells of the microplate by inserting the plurality of magnets and at least a part of each of the plurality of spacers of a magnetic particle separator device into the recesses of the microplate, such that the plurality of magnets are positioned adjacent to the sides of wells, and the magnetic fields produced by the magnets cause the magnetic particles suspended in biological sample to aggregate against the sides of the wells next to the magnets and away from the bottoms of the wells. The magnetic particle bound analyte may then be recovered from the unbound components of the biological sample by a series of steps that include removing the unbound biological sample, washing and rinsing. Recovering the magnetic particle bound analyte may also include incubating under appropriate conditions such that the analyte is eluted from the magnetic particles and separating the eluate from the magnetic particles.

When a magnetic particle separator of the current invention is joined together with a microplate, the magnets and spacers on the separation device are rigidly-secured to the base plate and oriented so that the magnets and at least a portion of the spacers will penetrate the recesses of the microplate, thereby causing the magnets to be positioned along the sides and away from the bottom of the microplate wells. In preferred embodiments, the distance between the bottoms of the wells and the magnets after insertion into the recesses of the microplate will be at least one third of the wells' total depth. In some embodiments, the distance between the bottoms of the wells and the magnets will be at least half of the wells' total depth. In still other embodiments, the distance between the bottoms of the wells and the magnets will be at least three quarters of the wells' total depth.

The magnets generate a strong, localized magnetic field focused at the side walls of the microplate wells. The magnetic field is capable of efficiently and effectively attracting the majority of magnetic particles suspended in biological sample to the sides of the wells and away from the bottom of the wells. This arrangement is particularly advantageous for biological samples held in deep-well microplates, as it allows more effective removal of the remaining unbound biological sample with minimal disturbance of the bound magnetic particles. The magnetic particles can then be subjected to further processing, such as washing, rinsing and elution.

The devices, systems and methods of the invention may be used in manual, semi-automated and automated magnetic particle separation processes, such as immunoprecipitations. Embodiments of the invention encompass the use of the devices, systems and methods in conjunction with automated liquid handling robotics.

### BRIEF DESCRIPTION OF THE DRAWINGS

FIGS. 1A and 1B illustrate the problems associated with conventional (prior art) devices and techniques for separating magnetic particles and analytes in deep well microplates. FIGS. 2A and 2B show, respectively, an isometric view of a magnetic particle separator device according to one embodiment of the present invention (FIG. 2A), and a graphical illustration of the principle of operation of embodiments of the present invention (FIG. 2B).

FIG. 2B shows a close up view of an embodiment of the invention, wherein an exemplary diametrically-charged magnet is positioned adjacent to the side of a well of a microplate, with the spacer being adjacent to the lower end of the well.

FIGS. 3A-D show exemplary geometric configurations and dimensions of an exemplary base plate configured in accordance with an embodiment of the present invention.

FIGS. 4A-D show, respectively, a vertical view (FIG. 4A), an isometric view (FIG. 4B), a top view (FIG. 4C), and a right side view (FIG. 4D), of an exemplary spacer that might be used in a magnetic particle separator configured according to one embodiment of the present invention.

FIG. 5 is an isometric view of an exemplary magnet suitable for use in some embodiments of the present invention.

FIGS. 6A, 6B, 7, 8A and 8B show, respectively, two front perspective views (FIGS. 6A and 6B), a top view (FIG. 7) and two side views (FIGS. 8A and 8B) of a magnetic particle separator according to one embodiment of the present invention.

FIG. 9 shows a top perspective view of an exemplary magnetic particle separation system according to an embodiment of the invention, including a magnetic particle separator and a deep-well microplate.

FIGS. 10-12 show various views of an embodiment of a magnetic particle separation system in which the magnets of the magnetic particle separator are inserted into the recesses of the deep-well microplate, including an isometric top view (FIG. 10), a bottom perspective view (FIG. 11) and a front perspective view (FIG. 12).

FIG. 13 shows a top orthogonal view of an exemplary deep well microplate used in some embodiments of the present invention.

FIGS. 14A and 14B show the orientation of the magnetic field vectors associated with a diametrically-charged magnet (FIG. 14A) and an axially-charged magnet (FIG. 14B).

FIG. 15 shows a top view of the wells in a microplate containing magnetic particles and analyte after separation using in an embodiment of the present invention.

FIG. 16 shows a flow diagram illustrating the steps performed to practice a magnetic particle separation method in accordance with one embodiment of the invention.

FIG. 17 shows a flow diagram illustrating the steps performed to practice a method of isolating analyte according to another embodiment of the invention.

While the invention has been described in detail with reference to specific examples, it will be apparent to one skilled in the art that various modifications can be made within the scope of this invention. Thus the scope of the invention should not be limited by the examples described herein, but by the claims presented below.

### DETAILED DESCRIPTION OF PREFERRED EMBODIMENTS

Before turning to the figures, a detailed overview of certain aspects of the invention will be provided. In one aspect, embodiments of the invention provide a magnetic particle separator for use with a microplate, comprising a base plate, a plurality of magnets and a plurality of spacers, each spacer having a first end and a second end, wherein the first ends of the plurality of spacers are secured to the base plate and the second ends of the plurality of spacers are secured to the plurality of magnets, and whereby the plurality of magnets are separated from the base plate by a distance of at least 15 mm. In some embodiments, the plurality of magnets is diametrically charged. In some embodiments, each of the plurality of spacers is cylindrical. In some embodiments, there are at least twenty-four magnets secured to at least twenty four spacers, the spacers being secured to the base plate, for use with a ninety-six well microplate.

In another aspect, the invention provides a magnetic particle separation system comprising a microplate having a plurality of wells for holding a plurality of biological samples containing magnetic particles and recesses being formed between the plurality of wells and a magnetic particle separator comprising a base plate, a plurality of magnets producing, respectively, a plurality of magnetic fields, and a plurality of spacers fixedly securing the plurality of magnets, respectively to the base plate, wherein the plurality of spacers imposes a sufficient distance between the plurality of magnets and the base plate, such that when the microplate and the magnetic separation device are joined together by inserting the plurality of magnets into the recesses of the microplate, the plurality of magnetic fields produced by the plurality of magnets cause the magnetic particles in the plurality of biological solutions to be attracted to the sides of the plurality of wells and away from the bottoms of said plurality of wells. In some embodiments, the distance between the bottoms of the wells and the plurality of magnets is at least 15 mm, when the microplate and the magnetic separator are joined together. In some embodiments, the plurality of magnets is diametrically-charged. In some embodiments, each of the plurality of spacers is cylindrical. In some embodiments, the magnetic particle separation system comprises at least twenty-four magnets secured to at least twenty four spacers, respectively, the twenty four spacers being secured to the base plate. In additional embodiments, the microplate is a deep-well microplate. In additional embodiments, the plurality magnetic fields produced by the plurality of magnets are oriented in the same orientation.

In an additional aspect, the present invention provides a method for separating magnetic particles and bound antibodies out of a plurality of biological samples contained in a microplate, the microplate having a plurality of wells with recesses formed therebetween, each well having a well depth, the method comprising providing a magnetic particle separator having a base plate, a plurality of magnets producing, respectively, a plurality of magnetic fields, and a plurality of spacers, each spacer fixedly securing one of the plurality of magnets to the base plate; and inserting the plurality of magnets and at least a portion of each spacer into the recesses between the wells of the microplate such that the distance between the bottoms of the wells and the plurality of magnets is equal to not less than one third of the well depth, whereby the plurality of magnetic fields produced by the plurality of magnets, respectively, cause the magnetic particles and bound antibodies in the plurality of biological samples to aggregate along the sides of the plurality of wells and away from the bottoms of the plurality of wells.

This method can be advantageously performed with the magnetic particle separator and the magnetic particle separation system of the invention described herein. In a preferred embodiment of the method according to the invention, the plurality of magnets is diametrically-charged. In another preferred embodiment of the method according to the invention, each of the plurality of spacers is cylindrical. In another preferred embodiment of the method, the well depth is at least 30 mm.

In still another aspect, the present invention provides a method for isolating an analyte from a biological sample held in a microplate, the microplate having wells and recesses therebetween, the wells having a well depth, the method comprising the steps of combining magnetic particles and the biological sample in the wells of the microplate, thereby producing a mixture, incubating the mixture under such conditions that the analyte binds to the magnetic particles, applying a magnetic field to the incubated mixture in the wells to cause the particles and bound analyte to move toward the sides and away from the bottoms of the wells and recovering the magnetic particle bound analyte. In accordance with this aspect of the invention, the magnetic field is, in preferred embodiments, applied by providing a magnetic particle separator having a base plate, a plurality of magnets that produces the magnetic field, and a plurality of spacers, each spacer fixedly securing one of the plurality of magnets to the baseplate; and inserting the plurality of magnets and at least a portion of each spacer into the recesses between the wells of the microplate so that the distance between the bottoms of the wells and the magnets is equal to not less than a third of the well depth. In another preferred embodiment, the well depth is at least 30 mm. Another preferred embodiment further includes the step of recovering comprises removing the non-bound components of the biological sample from the wells. Yet another preferred embodiment of the method for isolating an analyte further includes the step of recovering comprises removing the magnetic particle bound analyte from the wells.

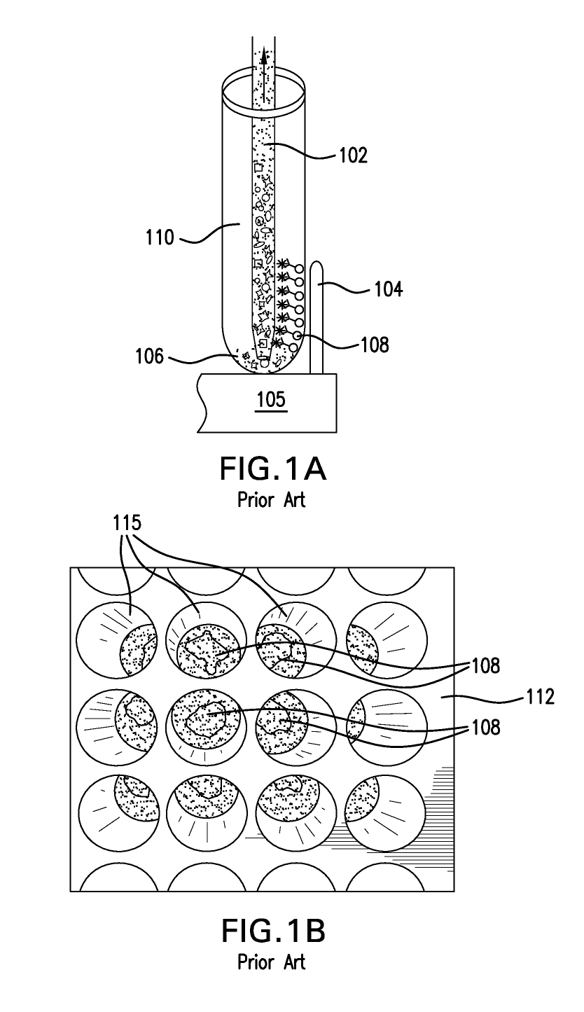

FIGS. 1A and 1B illustrate some of the problems associated with prior art devices and prior art techniques for separating bound magnetic particles from unbound biological sample in a deep well microplate. As shown best in FIG. 1A, when a magnet 104 and magnet-holding base 105 are placed next to the sides and bottom of a microplate well 110 containing unbound biological sample 106 and bound magnetic particles 108, a substantial number of the magnetic particles 108 are attracted to the sides and bottom of the well 110. Thus, when a pipette 102 is inserted the bottom of the well 110 in an attempt to remove unbound biological sample 106 from the well 110, the close proximity of bound magnetic particles 108 to the opening in the tip of the pipette 102 (caused by the location of the magnet 104) makes it very difficult to remove all of the undesired unbound biological sample 106 from the well 110 without also unintentionally removing some of the bound magnetic particles 108 from the well 110.

FIG. 1B shows a microplate 112 as viewed from above, i.e., looking down into the plurality of wells 115 in the microplate 112, after the unbound sample 106 has been removed. As can be seen in FIG. 1B, an abundance of the magnetic particles 108 are clumped together at the bottoms of the wells 115 after unbound biological sample 106 has been removed.

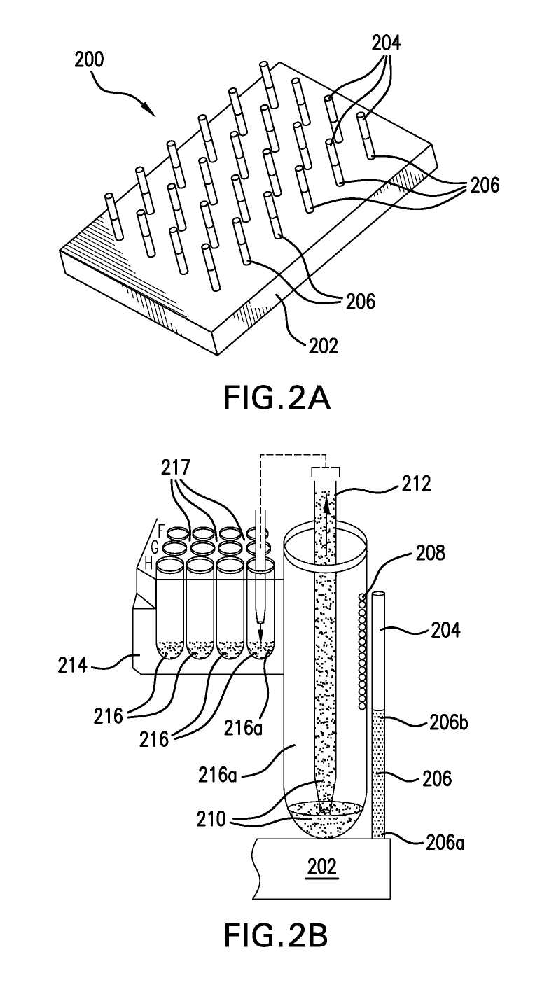

FIG. 2A illustrates one preferred embodiment (isometric view) of a magnetic particle separator 200 of the present invention. As shown in FIG. 2A, the magnetic particle separator 200 comprises a base plate 202, a plurality of magnets 204 and a plurality of spacers 206 fixedly securing the magnets 204 to the base plate 202. In this preferred embodiment, the plurality of magnets 204 and the plurality of spacers 206 are arranged in a 4×6 array. Hence, there are twenty-four magnets 204 and twenty-four spacers 206.

FIG. 2B shows a microplate 214 having a plurality of deep wells 216 and a plurality of recesses 217 (or “gaps”) interposed between the deep wells 216. For illustrative purposes, the right-most deep well 216a of microplate 214 is depicted in magnified form and brought into the foreground in order to show how embodiments of the present invention affect the contents of the deep wells. In practice, a magnetic particle separator 200 of the present invention is connected to the bottom of a microplate 214 such that the plurality of magnets 204 and the plurality of spacers 206 secured to the base plate 202 of magnetic particle separator 200 will pass into and remain within the recesses 217 between the plurality of deep wells 216. See the magnified portion of FIG. 2B showing the magnet 204 and the spacer 206 lying adjacent to the side of the deep well 216a and the base plate 202 adjacent to the bottom of the deep well 216a. As shown best in the magnified portion of FIG. 2B, each spacer 206 has a first end 206a and a second end 206b, the first end 206a of the spacer 206 being secured to the base plate 202, and the second end 206b of the spacer 206 being secured to the magnet 204. Because the spacer 206 imposes distance between the bottom of the deep well 216a and the magnet 204, the magnetic particles 208, as well as any analytes bound thereto, collect solely along the sides of the deep well 216a and relatively far away from the bottom of the deep well 216a, thereby permitting more unbound biological sample solution to be removed from the deep well 216a without disturbing or removing the analytes bound to the magnetic particles 208. More specifically, when the magnetic field generated by the magnet 204 passes through the deep well 216a containing unbound biological sample 210 and magnetic particles 108, the magnetic particles 208 are attracted to the side of the deep well 216a and away from the bottom of the deep well 216a. A pipette 212 may then be inserted all the way into the bottom of the deep well 216a of the microplate 214 to remove unbound biological sample 210 from the deep well 216a without also removing many, if any, of the bound magnetic particles 208 from the deep well 216a. Although only one spacer 206 and one magnet 204 are shown in FIG. 2B, it should be understood that, in practice, a plurality of magnets 204 attached to a plurality of spacers 206 on the magnetic particle separator 200 are inserted into the plurality of recesses 217 between the plurality of wells 216 so as to have the same effect on the magnetic particles and bound analyte in all of the deep wells 216 of microplate 214.

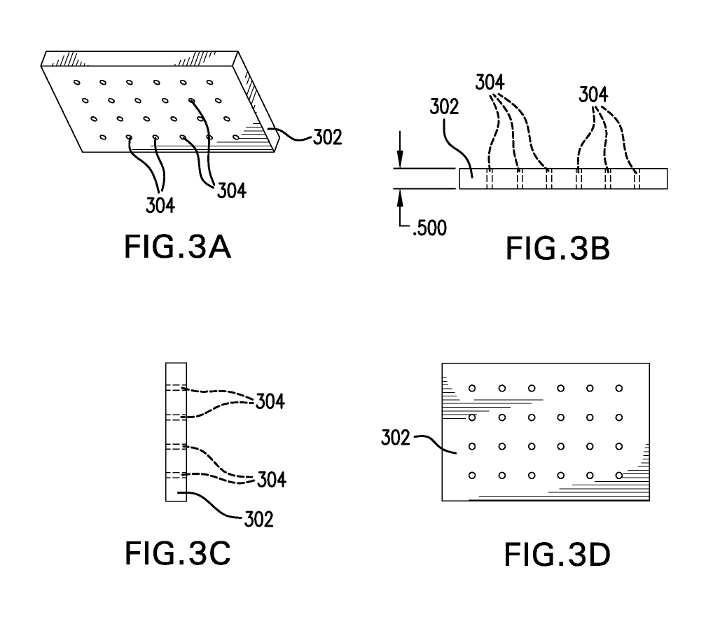

The geometric configuration and dimensions of an exemplary base plate 302 configured in accordance with an embodiment of the present invention are illustrated in FIG. 3A (isometric view), FIG. 3B (schematic side view), FIG. 3C (schematic end view) and FIG. 3D (schematic top view). The base plate 302 is typically approximately ⅜ to ⅝ inch thickness and, in a preferred embodiment, has overall dimensions of approximately 3.4 inches×5.0 inches. (FIG. 3D). The illustrated base plate 302 has twenty-four openings 304 arranged in a 4×6 array. (FIGS. 3A and 3D) The openings 304 are generated by drilling holes through the thickness of the base plate 302 and typically have a depth of less than or equal to the thickness of the base plate 302. In the illustrated base plate 302, the openings 304 have a depth of approximately 0.5 inches (FIGS. 3B and 3C).

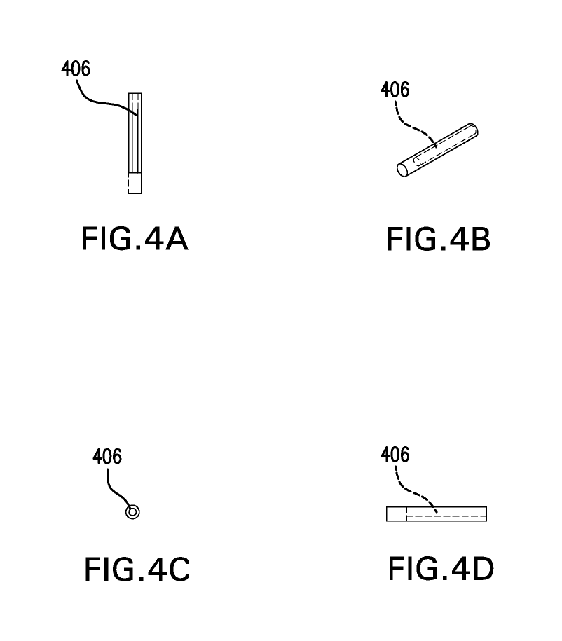

An exemplary spacer 406 that can be press fit into an opening 304 in the base plate 302 of FIG. 3 configured in accordance with the present invention is depicted in FIG. 4A (vertical view), FIG. 4B (isometric view), FIG. 4C (top view) and FIG. 4D (right side view). The spacer 406 is stainless steel syringe tubing holders that are 1 inch long (FIGS. 4A, 4B, and 4D) and have an outside diameter of 0.125 inches (FIG. 4C) and an inside diameter of 0.0625 inches (FIG. 4D). The tubing holders are modified by drilling bores into one end of each tube, the bores being approximately 0.200 inches deep (FIG. 4D). This drilling process includes successively drilling bores with diameters of 0.110 inches, 0.116 inches and 0.118 inches to obtain the proper inside diameter to install the magnets 204.

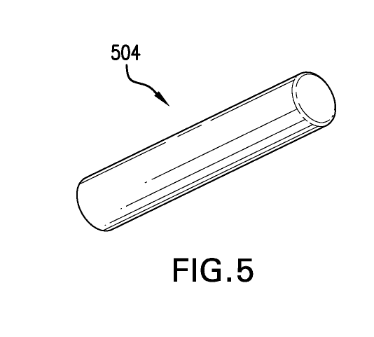

FIG. 5 provides an isometric view of an exemplary magnet 504 that is suitable for use in connection with some embodiments of the present invention. The magnet 504 is preferably cylindrical, as illustrated, although other shapes may be used as well. The magnet 504 is preferably about 5 mm—about 25 mm in length, and can be fabricated from many different materials, including, but not limited to, rare earth materials, in order to provide strong magnetic fields adjacent to and along the sides of the deep wells 216 of the microplate 214 (See FIG. 2B). Exemplary suitable magnets may include, without limitation, neodymium and samarium-cobalt magnets.

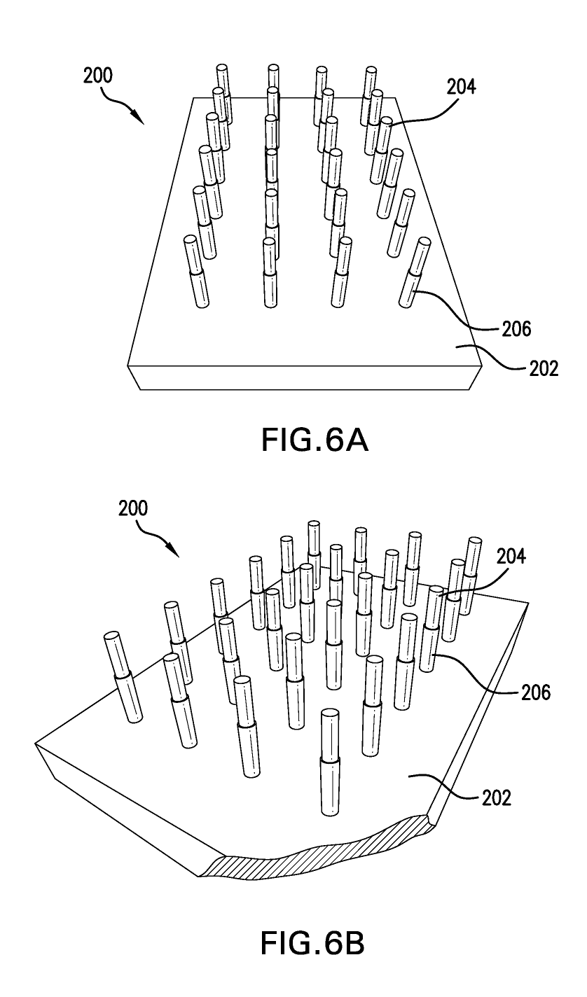

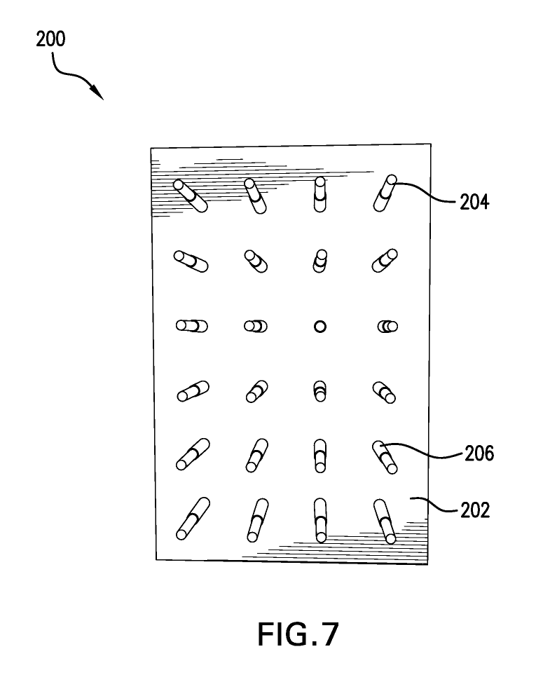

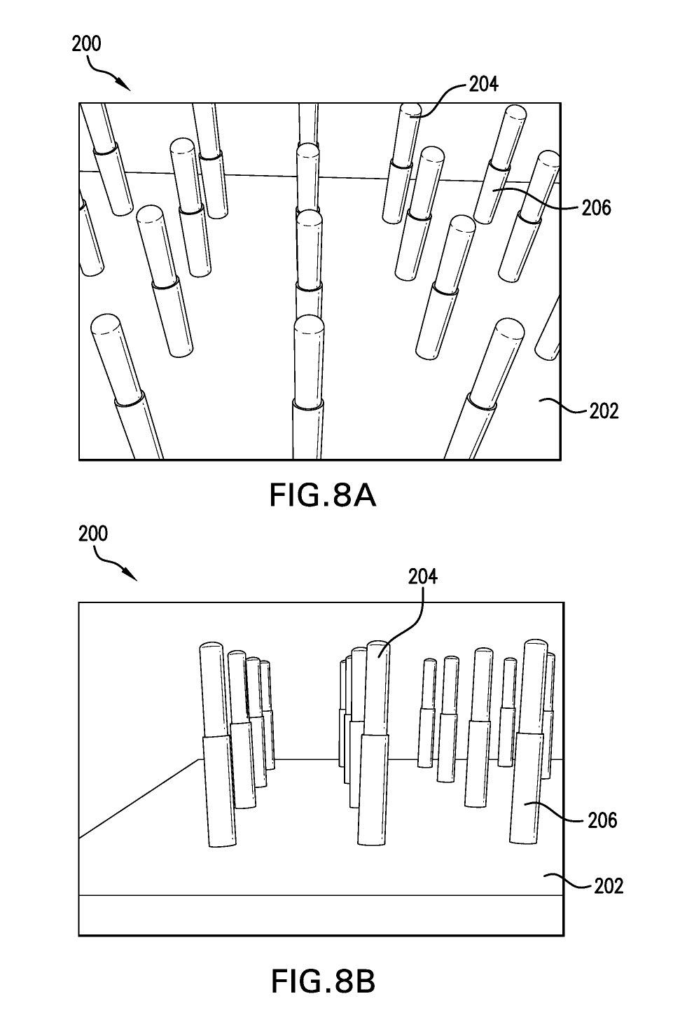

FIGS. 6A, 6B, 7, 8A and 8B show, respectively, two front perspective views (FIGS. 6A and 6B), a top view (FIG. 7) and two side views (FIGS. 8A and 8B) of the exemplary embodiment of a magnetic particle separator 200 illustrated in FIG. 2A. In each of these figures, it can be seen that the magnetic particle separator 200 includes a plurality of spacers 206 connecting a plurality of magnets 204 to a base plate 202.

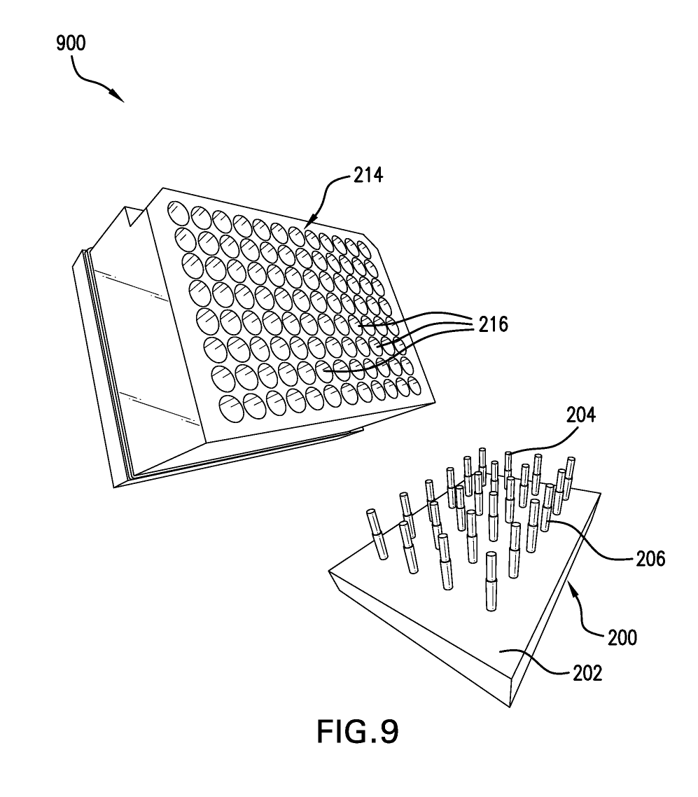

FIG. 9 shows a top view of a magnetic particle separation system 900 according to one embodiment of the present invention. The magnetic particle separation system 900 comprises a microplate 214 having wells 216 for holding biological samples and recesses 217 formed between the wells 216, and a magnetic particle separator 200 comprising: a) a base plate 202, b) a plurality of magnets 204 and c) a plurality of spacers 206. FIG. 9 shows the magnetic particle separator 200 separated from the deep well microplate 214.

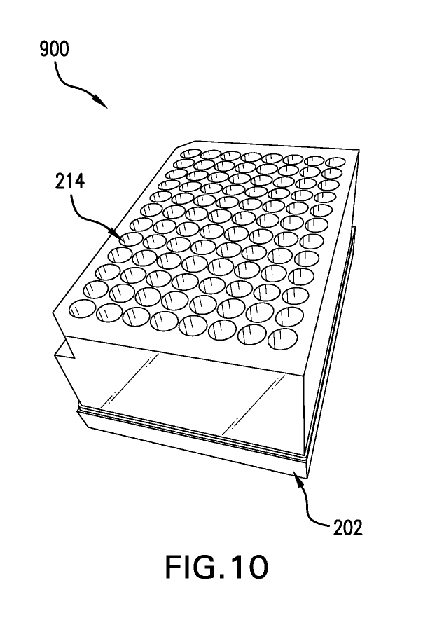

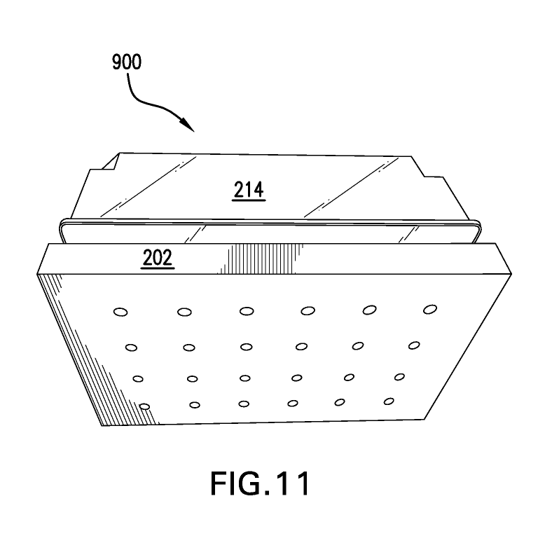

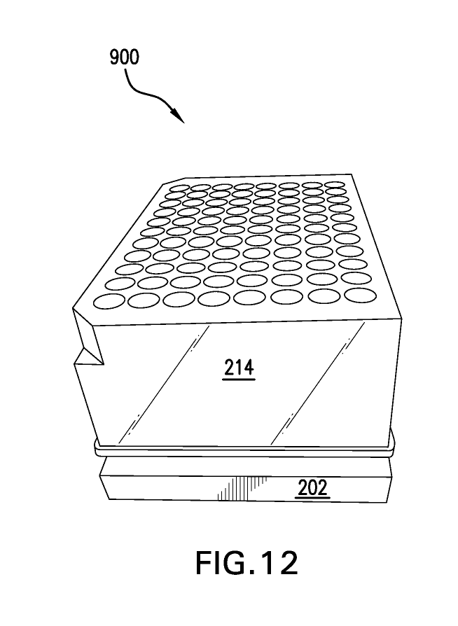

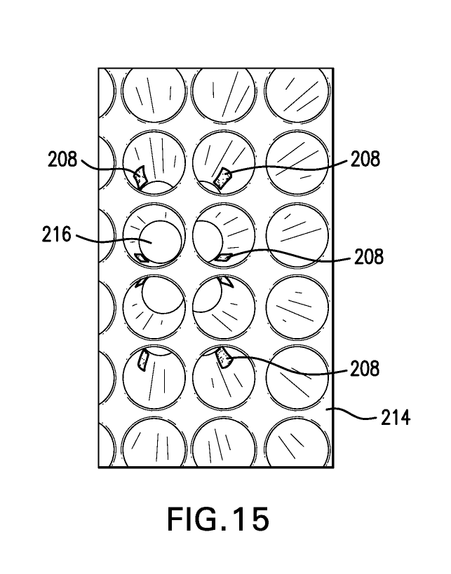

The magnetic particle separator 200 is configured to position one magnet 204 in the recess 217 between every grouping of four deep wells 216 of the microplate 214 so that the magnetic fields produced by the magnets 204 cause the magnetic particles 208 in the biological sample to aggregate along the sides of the deep wells 216 closest to the charged magnets 204. The spacers 206 are interposed between the base plate 202 and the magnets 204 such that when the magnets 204 and the spacers 206 are inserted into the recesses 217 of the microplate 214, as shown in FIGS. 10-12, the magnets 204 are positioned adjacent to the sides of the wells 216. When the microplate 214 and the magnetic particle separator 200 are joined together by inserting the plurality of magnets 204 into the recesses 217 of the microplate 214, the plurality of spacers 206 imposes a sufficient distance between the plurality of magnets 204 and the bottoms of the wells 216 so that the plurality of magnetic fields produced by the plurality of magnets 204 cause the magnetic particles 208 in the plurality of biological samples to be attracted to the sides of the plurality of wells 216 and away from the bottoms of the wells 216, as depicted in FIGS. 2B and 15.

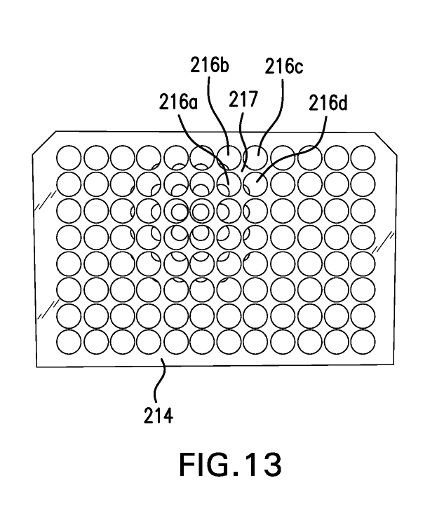

FIG. 13 shows a top orthogonal view of an exemplary deep well microplate 214 suitable for some embodiments of the present invention. The illustrated microplate 214 contains 96 wells arranged in an 8×12 array. There is one recess 217 between each grouping of four wells 216a, 216b, 216c and 216d and a total of twenty four recesses into which each of the twenty four magnets 204 and spacers 206 of the magnetic separator device 200 may be inserted.

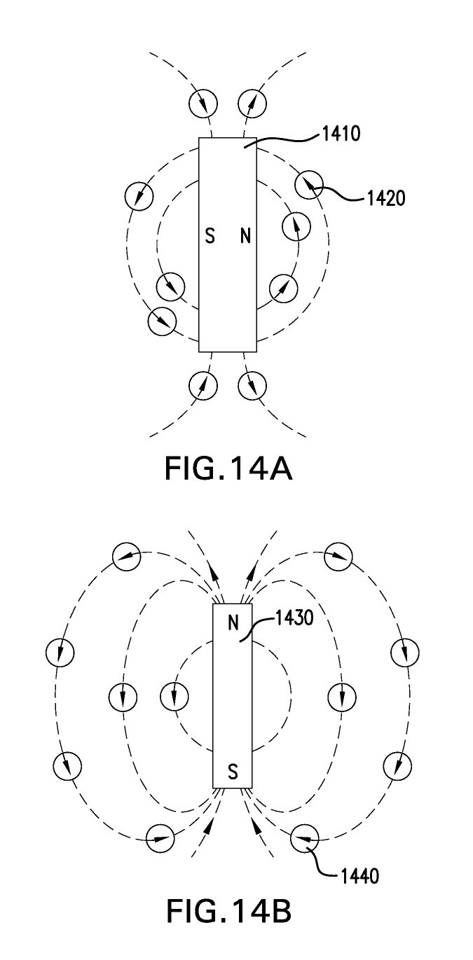

FIG. 14A shows a diametrically charged magnet 1410 with concomitant magnetic field vectors 1420. As shown in FIG. 14A, the north and south poles of diametrically charged magnet 1410 (designated “N” and “S” in FIG. 14A) are situated at along the sides of the diametrically charged magnet 1410. The magnetic field vectors 1420 surrounding diametrically charged magnet 1410 are oriented such that they are directed to the sides of the magnet 1410, with the vectors 1420 pointing away from the North pole (N) and towards the South pole (S) of the magnet 1410. Notably, the vectors 1420 run in the same direction to which the magnetic particles are targeted in the present invention, i.e., towards the sides of the microplate wells that would be positioned adjacent to the magnets 1410.

FIG. 14B shows an axially-charged magnet 1430. As shown by FIG. 14B, the north and south poles of axially-charged magnet 1430 are situated at the ends of the magnet 1430. Furthermore, the magnetic field vectors 1440 for axially charged magnet 1430 are directed towards the south end of axially-charged magnet 1430, which causes magnetically charged particles in a microplate well coming into range of magnetic field vectors 1440 to be more attracted to the south end of the magnet 1430, which is the end that would be located closer to the bottom of microplate wells that would be positioned adjacent to the magnet 1430.

FIG. 15 shows a top view of the wells 216 in a microplate 214 containing magnetic particles 208 and analyte after separation using in an embodiment of the present invention. As shown in FIG. 15, the collection of magnetic particles 208 attached to the sides of the individual microplate wells 216 as a result of being subjected to the magnetic fields produced by the diametrically charged magnets 204 located adjacent to the sides of the wells is quite uniform and relatively far from the bottoms of the wells 216.

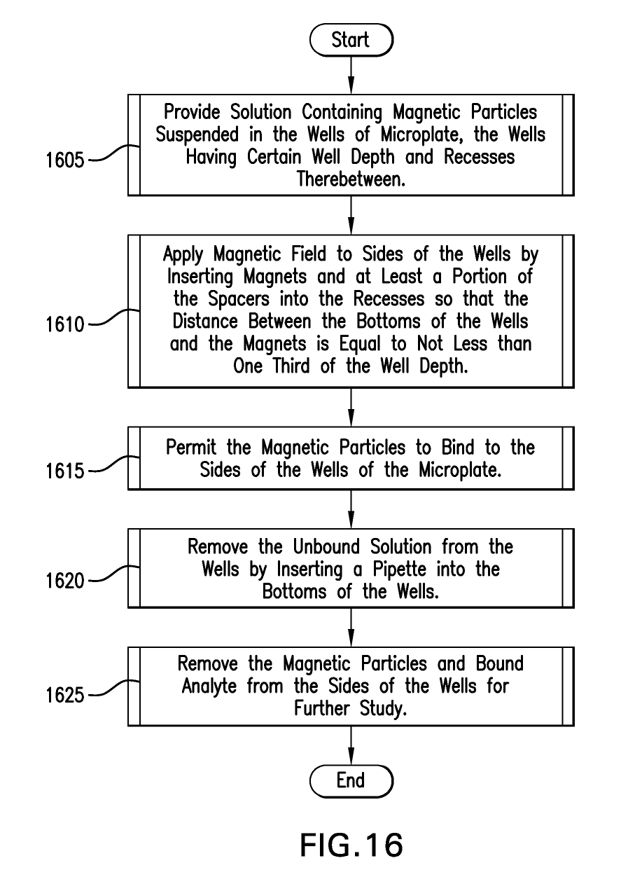

FIG. 16 shows a flow diagram illustrating the steps performed to practice a magnetic particle separation method using a magnetic particle separation system 900 in accordance with one embodiment of the invention. More specifically, FIG. 16 illustrates a method for separating magnetic particles 208 and bound analyte out of a plurality of biological samples contained in a microplate 214. The microplate 214 has a plurality of wells 216 with recesses formed therebetween.

The method is initiated, at step 1605, by providing a solution containing magnetic particles 208 that are suspended in the wells 216 of a microplate 214. The wells 216 have a certain well depth, preferably at least 30 mm, and recesses formed therebetween. Next, in step 1610, a magnetic field is applied to the sides of the wells 216 of the microplate 214 by inserting a plurality of magnets 204 and at least a portion of each of a plurality of spacers 206 of a magnetic particle separator 200 into the recesses. The magnets are inserted into the recesses so that the distance between the bottoms of the wells 216 and the magnets is equal to not less than one third of the well depth. The magnetic particles 208 are permitted to bind to the sides of the wells 216 of the microplate 214. The time and temperature required for binding may vary according to the analyte and the magnetic particles. After allowing sufficient time for binding, step 1620 is performed. In step 1620, unbound solution 102 is removed from the microplate wells 216 by inserting a pipette 212 or similar apparatus into the bottom of the wells 216 of the microplate 214. The method is completed at step 1625, by removing the magnetic particles 208 and bound analyte from the sides of the wells 216 of the microplate 214.

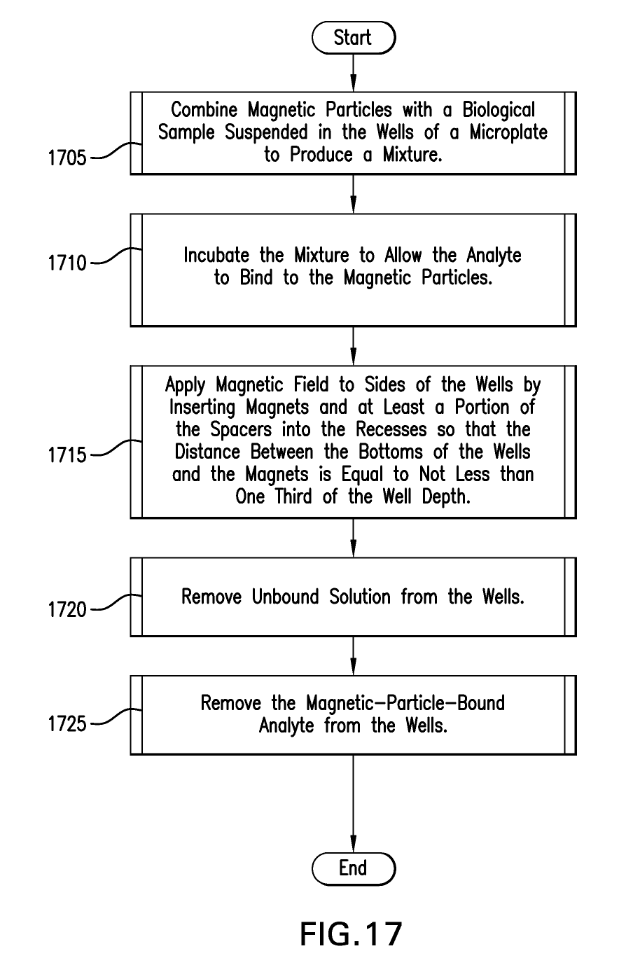

FIG. 17 shows a flow diagram illustrating the steps performed to practice a method of isolating an analyte according to another embodiment of the invention. More specifically, FIG. 17 illustrates a method for separating magnetic particle-bound-analyte out of a plurality of biological samples contained in a microplate 214. The microplate 214 has a plurality of wells 216 with recesses formed therebetween. Each well has a certain well depth. In the first step, step 1705, magnetic particles 208 are combined with a biological sample that is suspended in the wells 216 of a microplate 214 to produce a mixture. The mixture is then incubated to allow the analyte to bind to the magnetic particles 208 (step 1710). After the incubation is completed, a magnetic field is applied to the sides of the wells 216 by inserting the plurality of magnets 204 and a least a portion of each of the plurality of spacers of a magnetic particle separator 200 into the recesses of the microplate 214 so that the distance between the bottoms of the wells and the magnets 204 is equal to not less than one third of the well depth. (Step 1715). At step 1720, unbound solution 102 is removed from the wells, using a pipette or other apparatus. And finally, at step 1725, the magnetic particle-bound-analyte is removed from the wells 216 of the microplate 214.

It will be understood that where embodiments of the invention have been illustrated in a flowchart, any of the steps illustrated may be combined, modified or deleted, where appropriate, and/or additional steps may also be added to those shown in the flowchart. The described steps may be performed in any suitable order without departing from the scope of the present invention.

It will also be understood that the invention has been described with respect to specific embodiments that are intended to be illustrative, not limiting, and that modifications may be made without departure from the spirit and scope of the invention.

What is claimed is:

1. A magnetic particle separator for use with a microplate, comprising:
a) a base plate;
b) a plurality of magnets; and
c) a plurality of spacers, each having a first end and a second end;
d) wherein the first ends of said plurality of spacers are secured to the base plate and the second ends of said plurality of spacers are secured to said plurality of magnets;
e) whereby said plurality of magnets are separated from said base plate by a distance of at least 15 mm.

2. The magnetic particle separator of claim 1, wherein the plurality of magnets are diametrically charged.

3. The magnetic particle separator of claim 1, wherein each of the plurality of spacers is cylindrical.

4. The magnetic particle separator of claim 1, wherein there are at least twenty-four magnets secured to at least twenty four spacers, said spacers being secured to said base plate, for use with a ninety-six well microplate.

5. A magnetic particle separation system comprising:
a) a microplate having a plurality of wells for holding a plurality of biological samples containing magnetic particles and recesses being formed between the plurality of wells; and
b) a magnetic particle separator comprising a base plate, a plurality of magnets producing, respectively, a plurality of magnetic fields, and a plurality of spacers fixedly securing the plurality of magnets, respectively to the base plate;
c) wherein said plurality of spacers imposes a sufficient distance between the plurality of magnets and the base plate, such that when the microplate and the magnetic separation device are joined together by inserting the plurality of magnets into the recesses of the microplate, the plurality of magnetic fields produced by said plurality of magnets cause the magnetic particles in the plurality of biological solutions to be attracted to the sides of the plurality of wells and away from the bottoms of said plurality of wells.

6. The magnetic particle separation of claim 5, wherein when the microplate and the magnetic separator are joined together, the distance between the bottoms of the wells and the plurality of magnets is at least 15 mm.

7. The magnetic particle separation system of claim 5, wherein the plurality of magnets are diametrically-charged.

8. The magnetic particle separation system of claim 5, wherein each of the plurality of spacers is cylindrical.

9. The magnetic particle separation system of claim 5, comprising at least twenty-four magnets secured to at least twenty four spacers, respectively, said twenty four spacers being secured to said base plate.

10. The magnetic particle separation system of claim 5, wherein the microplate is a deep-well microplate.

11. The magnetic particle separation system of claim 5, wherein the plurality of magnetic fields produced by said plurality of magnets are oriented in the same orientation.

12. A method for separating magnetic particles and bound antibodies out of a plurality of biological samples contained in a microplate, the microplate having a plurality of wells with recesses formed therebetween, each well having a well depth, the method comprising:
a) providing a magnetic particle separator having a base plate, a plurality of magnets producing, respectively, a plurality of magnetic fields, and a plurality of spacers, each spacer fixedly securing one of the plurality of magnets to the base plate; and
b) inserting the plurality of magnets and at least a portion of each spacer into the recesses between the wells of the microplate such that the distance between the bottoms of the wells and the plurality of magnets is equal to not less than one third of the well depth;
c) whereby the plurality of magnetic fields produced by the plurality of magnets, respectively, cause the magnetic particles and bound antibodies in the plurality of biological samples to aggregate along the sides of the plurality of wells and away from the bottoms of said plurality of wells.

13. The method of claim 12, wherein each of the plurality of magnets is diametrically charged.

14. The method of claim 12, wherein each of the plurality of magnets is cylindrical.

15. The method of claim 12, wherein the well depth is at least 30 mm.

16. A method for isolating an analyte from a biological sample held in a microplate, the microplate having wells and recesses therebetween, the wells having a well depth, the method comprising the steps of:
a) combining magnetic particles and the biological sample in the wells of the microplate, thereby producing a mixture;
b) incubating the mixture under such conditions that the analyte binds to the magnetic particles;
c) applying a magnetic field to the incubated mixture in the wells to cause the particles and bound analyte to move toward the sides and away from the bottoms of the wells; and
d) recovering the magnetic particle bound analyte.

17. The method of claim 16, wherein said magnetic field is applied by
a) providing a magnetic particle separator having a base plate, a plurality of magnets that produces the magnetic field, and a plurality of spacers, each spacer fixedly securing one of said plurality of magnets to the baseplate; and
b) inserting the plurality of magnets and at least a portion of each spacer into the recesses between the wells of the microplate so that the distance between the bottoms of the wells and the magnets is equal to not less than a third of the well depth;

18. The method of claim 16, wherein the well depth is at least 30 mm.

19. The method of claim 16, wherein the step of recovering comprises removing the non-bound components of the biological sample from the wells.

20. The method of claim 16, wherein the step of recovering comprises removing the magnetic particle bound analyte from the wells.
